(19) United States
(12) Patent Application Publication
(10) Pub. No.: US 2011/0304609 A1
(43) Pub. Date: Dec. 15, 2011

(54) Design Support Apparatus and Design Support Method

(76) Inventors: Yasushi SASAKI, Tokyo (JP); Tadashi AKIYOSHI, Tokyo (JP)

(21) Appl. No.: 13/044,434

(22) Filed: Mar. 9, 2011

(30) Foreign Application Priority Data
Jun. 15, 2010 (JP) 2010-136507

(51) Int. Cl. G06T 15/00

(52) U.S. Cl. 345/419

(57) ABSTRACT

An embodiment of the design support apparatus includes: a component database in which 3D shape data of each component in equipment and 3D layout data of each component are stored as component data for each component; a design criteria database in which information defining an inter-component distance between a first component and a second component to be verified and determination criteria used for verification of the inter-component distance are stored; a distance calculation unit which extracts component data of each of the first component and the second component from the component database, and calculates the inter-component distance from each of the extracted component data; and a determination unit which determines whether or not the calculated inter-component distance satisfies the determination criteria.

### CROSS-REFERENCE TO RELATED APPLICATIONS

This application claims the benefit of priority of Japanese Patent Application No. 2010-136507, filed Jun. 15, 2010, the entire contents of which are incorporated herein by reference.

### FIELD

The present invention relates to a design support apparatus and a design support method for supporting a 3D mechanical design.

### BACKGROUND

In recent years, a 3D CAD (3-Dimensional Computer-Aided Design) is widely used in mechanical design of equipment such as a vehicle and an electronic device. In the 3D CAD, the shapes, sizes, and the like of various components used in the equipment are stored as a database. For example, the designer starts designing by fetching data of each component from the database and arranging the component data in each position inside the equipment.

In the course of designing, it is one of the important design verification items to check whether or not the arranged components contact (interfere) with each other.

As is well known, today's small electronic equipment, such as a notebook-type personal computer, moves more and more toward reduction in component size and toward high density mounting of components. The trend toward high density mounting of components involves diversified design verification items about mechanical design, and thus a simple determination of the presence or absence of inter-component interference is not sufficient. Further, the design verification requires increasing time and cost.

For example, consider the case in which the distance between the two components is measured in order to check whether or not the arrangement of designed components satisfies the design criteria. Conventionally, it is common that first, the generated 3D data is read and displayed on the screen, and then the position to be verified is visually found and determined. When the position to be verified is exposed outside the 3D data, the distance can be measured as is. However, the position to be verified is inside the 3D data, it is necessary to generate a 2D cross-sectional drawing including the position from the 3D data and manually measure the distance on the cross section. Then, a determination is made as to whether or not the measured distance satisfies the design criteria. Such a series of operations from determination of verification positions up to distance measurement and determination based on the design criteria is repeated until all verification positions are covered. Thus, the conventional design verification using a 3D CAD (design support apparatus) requires a lot of time and efforts.

In light of this, what is needed is a design support apparatus and a design support method which can efficiently perform design verification and handle diversified design verification items.

### BRIEF DESCRIPTION OF THE DRAWINGS

FIG. 1 illustrates a configuration example of a design support apparatus according to an embodiment;

FIGS. 2A to 2C describe an example of a conventional verification method;

FIG. 3 is flowchart illustrating an example of an inter-component distance verification method according to the present embodiment;

FIG. 4 is a schematic drawing of design criteria data stored in a design criteria database;

FIG. 5 illustrates a first display example of a determination result;

FIGS. 6A to 6C illustrate a second display example of a determination result;

FIG. 7 illustrates an example of a component layout to be verified; and

FIG. 8 illustrates a display example of a selection screen and a change screen of design criteria data.

### DETAILED DESCRIPTION

An embodiment of the design support apparatus comprises: a component database in which 3D shape data of each component in equipment and 3D layout data of each component are stored as component data for each component; a design criteria database, which is a database in which a plurality of verification items can be stored, and in which information defining an inter-component distance between a first component and a second component to be verified and determination criteria used for verification of the inter-component distance are stored for each of the verification items; a distance calculation unit which, based on the information defining the inter-component distance, extracts component data of each of the first component and the second component from the component database, and calculates the inter-component distance from each of the extracted component data for each of the verification items; and a determination unit which determines whether or not the calculated inter-component distance satisfies the determination criteria for each of the verification items.

A design support apparatus 1 and a design support method according to an embodiment of the present invention will be described by referring to accompanying drawings.

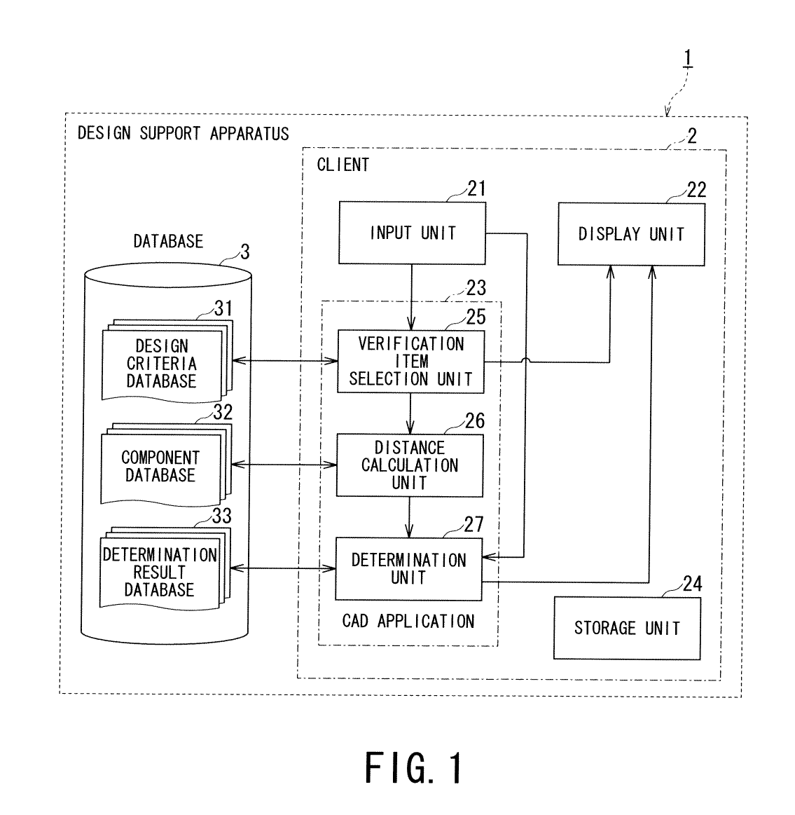

FIG. 1 is a block diagram illustrating a configuration example of the design support apparatus 1. The design support apparatus 1 includes a client 2 configured of a personal computer or the like and a database 3.

The client 2 is a computer configured to include an input unit 21 such as a keyboard and a mouse, a display unit 22 having a display panel and the like, a storage unit 24 including an HDD and the like, and a CPU (processor) (not illustrated), and the like. The CPU can execute CAD application software 23. The design support apparatus 1 according to the present embodiment is configured to allow the CAD application software 23 to execute each function of a verification item selection unit 25, a distance calculation unit 26, and a determination unit 27 described later.

The database 3 includes a design criteria database 31, a component database 32, and a determination result database 33 as its detailed configuration.

According to the configuration illustrated in FIG. 1, the client 2 is configured separately from the database 3 so as to allow the database 3 to be accessed from a plurality of clients 2. Alternatively, a storage unit 24 in the client 2 is configured to have the same function that the database 3 has.

In general, the mechanical design using the CAD application software 23 is such that component data about the shape and the like of a component for use in equipment such as an electronic device is preliminarily stored in a component database 32, and necessary component data is read from the component database 32 as needed and arranged in an appropriate position in the equipment. Moreover, the mechanical design of an equipment-specific component such as a support member of a component and a case for storing part or all of the components is also performed using the CAD application software 23. The layout data of the component subjected to layout design and the shape data of the support member, the case, and the like are stored again in the component database 32.

The high density mounting design is such that not only the inter-component distance is shortened but also the component layout is performed three-dimensionally. Therefore, it is very important to verify the presence or absence of inter-component interference after or in the middle of design. Moreover, it is very important not only to simply verify the presence or absence of inter-component interference, but also to verify whether or not the inter-component distance matches predetermined design criteria. For example, a moving component such as a mechanical switch needs to be verified to check whether or not the shortest distance to the surrounding components is determined in consideration of the movement of the moving part of the switch. Further, when a screw and a boss are arranged, it is required to sufficiently verify whether or not the layout ensures a predetermined screw-in amount.

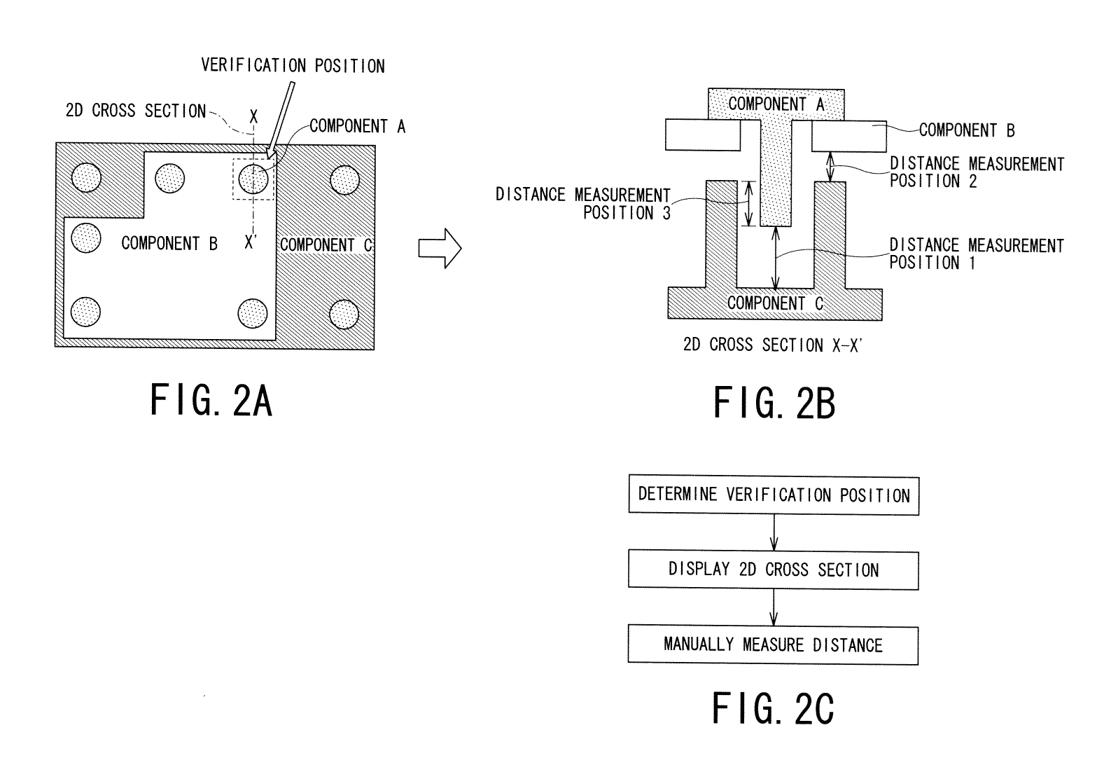

FIGS. 2A to 2B illustrate an example of verification work using conventional CAD application software. FIG. 2A is a top view schematically illustrating part of CAD data of an electronic device. In the present embodiment, a plate-like component B is placed on part of a plate-like component C and a component A is placed on the component B so as to pass through thereon. The component C is, for example, a printed circuit board having a boss portion and the component A is a screw.

Only the top view of FIG. 2A is not sufficient to verify the distance between the components A, B, and C. In light of this, conventionally, verification is performed using a flow as illustrated in FIG. 2C. More specifically, first, a verification position is determined and then a 2D cross section X-X′ is displayed as illustrated in FIG. 2B. Then, the distances to be verified are manually measured. For example, when a distance measurement position 1 is measured, first, a distal surface of the component A is selected by a pointer or the like and then an internal bottom surface of the component C is selected. Then, the distance between the two surfaces is displayed and measured. Then, when a distance measurement position 2 is measured, a rear surface of the component B and an upper surface of the boss portion of the component C are selected by a pointer or the like. Then, the distance between the two surfaces is measured. Thus, the conventional verification work using CAD application software takes a lot of time and efforts.

In contrast to this, the design support apparatus 1 according to the present embodiment provides an efficient verification of inter-component distance by greatly automating the verification process.

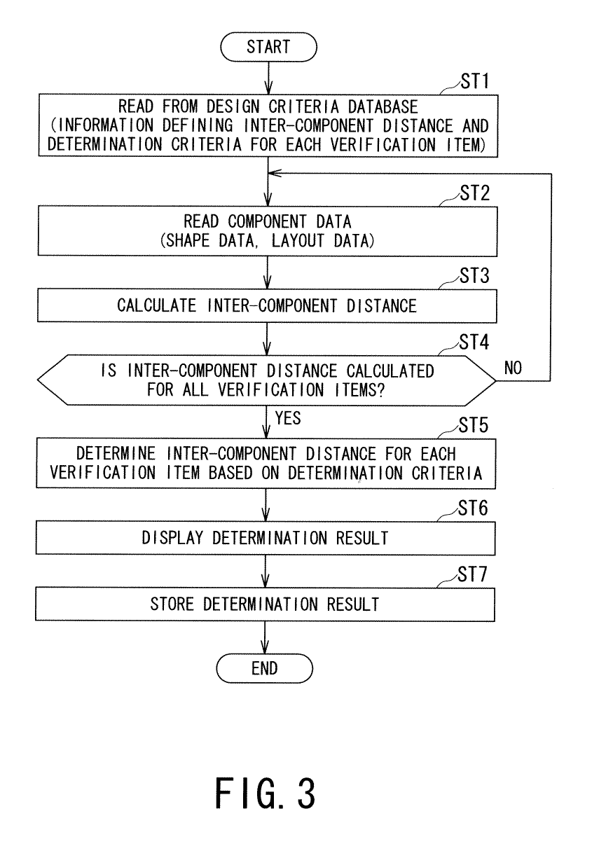

FIG. 3 is flowchart illustrating an example of an inter-component distance verification method performed by the design support apparatus 1 according to the present embodiment. One of the features of this verification method is that a database called a design criteria database is provided in advance, a verification procedure is automatically performed based on the design criteria database, and whether or not the inter-component distance is acceptable is automatically determined based on the determination criteria stored in the design criteria database.

First, in step ST1, the verification item selection unit 25 reads design criteria data from the design criteria database 31 of the database 3. As described later, a user may generate the design criteria data by using the design support apparatus 1, and store the design criteria data in the design criteria database 31. The user may also change or update the design criteria data read from the design criteria database 31.

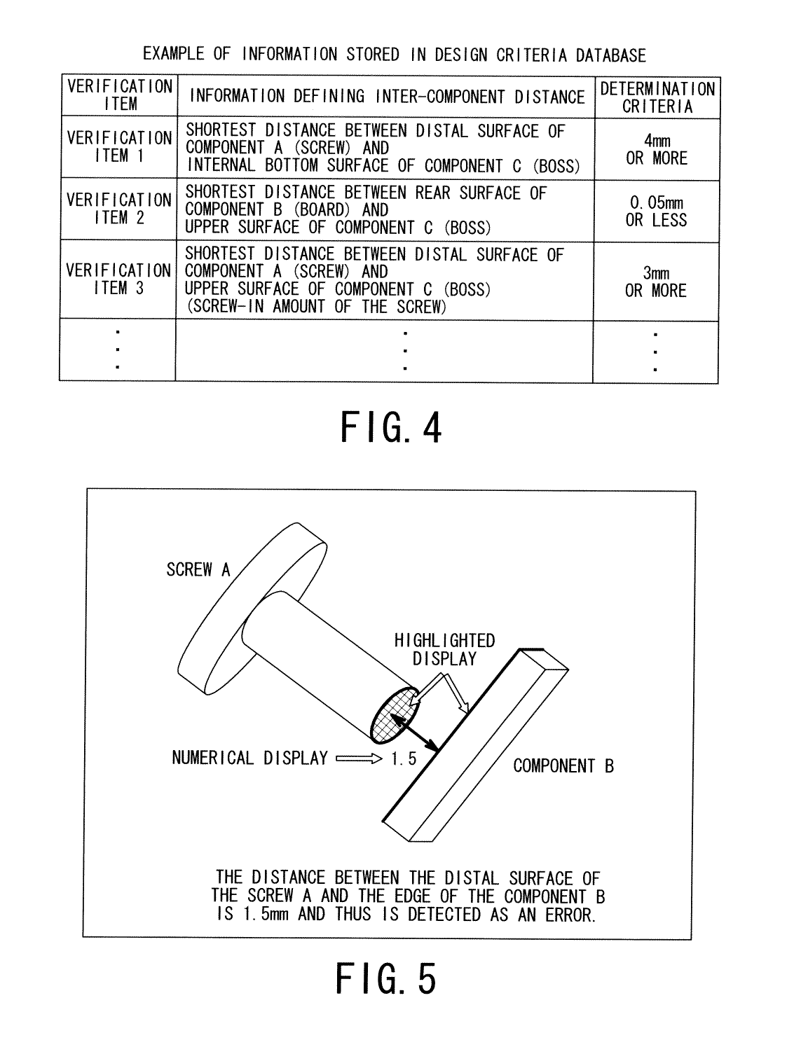

FIG. 4 is an example of the design criteria data. The design criteria data is a description of a plurality of verification items. For each verification item, the design criteria data includes at least information defining an inter-component distance between the two components (a first component and a second component) to be verified and a determination criteria used for verification of the inter-component distance. In an example of FIG. 4, the information defining the inter-component distance of the verification item 1 specifies “the shortest distance between the distal surface of the component A (screw) and the internal bottom surface of the component C (boss)” and the determination criteria of the verification item 1 specifies “4 mm or more”. The information defining the inter-component distance of the verification item 2 specifies “the shortest distance between the rear surface of component B (board) and the upper surface of component C (boss) and the determination criteria of the verification item 2 specifies “0.05 mm or less”.

As the information defining the inter-component distance, in the example illustrated in FIG. 4, a specific region of the component surface is specified for each of the two components as the distal surface of the component A (screw) and the internal bottom surface of the component C (boss). Here, the specific region refers to a specific point, a specific edge, a specific surface, or the like.

Alternatively, without specifying a specific region for one or both of the two components, such a specification as simply “the shortest distance between the component A and the component B”, or “the shortest distance between a specific region of the components A and the component B” may be possible.

Alternatively, when the first component of the two components is one of a large number of components each having the same 3D shape and being arranged in a different position on the same surface (such as the same type of screw) and the second component is a bottom plate parallel to the surface on which the screw is placed, a verification item is not separately set to each screw, but an inter-component distance can be defined as one verification item. For example, the inter-component distance can be defined as “the shortest distance between the screw of type A and the bottom plate”. In this case, even if there are a large number of screws of type A, it is sufficient to set one verification item, thus facilitating inputting the verification items or changing the verification items.

Further, the design support apparatus 1 according to the present embodiment provides diversified methods of setting the determination criteria. In order to determine only the presence or absence of interference between the two components, it is sufficient to determine whether or not the distance between the two components is “equal to or greater than” a predetermined criterion. In contrast to this, the present embodiment allows the user to set a determination criterion from the inter-component distances being: (1) equal to or greater than a predetermined design criterion; (2) equal to or less than a predetermined design criterion; (3) less than a predetermined design criterion; (4) greater than a predetermined design criterion; (5) the same as a predetermined design criterion; and (6) within a predetermined design criteria range. As a result, the present embodiment can provide not only a simple determination of the presence or absence of inter-component interference but also various design verification, such as a verification of the screw-in amount of the screw, or a verification whether a component is located in a range 10 mm to 13 mm away from a side wall of the case.

Now, by referring back to FIG. 3, in step ST2, the distance calculation unit 26 extracts and reads component data of the two components from the component database 32 for each verification item. The component data to be read includes shape data and layout data of the corresponding component. In step ST3, the distance calculation unit 26 calculates the distance between the two components from the read component data.

When the distance between the two components is defined by a specific region on each component surface, the distance between the defined specific regions can be calculated from the shape data and the layout data. Meanwhile, when the distance between the two components is defined as “the shortest distance between the component A and the component B”, the shape data and the layout data of the respective components are used to search the entire surfaces of the component A and the component B to determine the closest positions respectively and calculate the distance between the determined closest positions.

The process in step ST2 to step ST3 is repeated until the inter-component distance is calculated for all verification items. If the inter-component distance is calculated for all verification items (step ST4: YES), the process moves to step ST5, in which the determination unit 27 determines whether or not the inter-component distance is acceptable for each verification item based on the determination criteria. Then, in step ST6, the determination result is displayed on the display unit 22.

The design support apparatus 1 according to the present embodiment displays the shape and the layout of each component in the equipment to be designed on the display unit 22 as a 3D image or a 2D image in such a manner that only the components determined not to satisfy the determination criteria are displayed and the components determined to satisfy the determination criteria are automatically erased and hidden.

Today's electronic equipment includes a large number of small components which are three-dimensionally overlapped with each other and mounted at high density. Thus, in order to identify the components determined not to satisfy the determination criteria, it is necessary to erase the surrounding component images. However, in order to erase the images of unwanted components, the conventional CAD application software requires the user to specify the components one at a time to erase them. In contrast to this, the design support apparatus 1 according to the present embodiment displays only the components determined not to satisfy the determination criteria, and thus the user (designer) can very efficiently identify or find the necessary images (images of the components required for design change).

FIG. 5 illustrates a first display example of the determination result. In the example illustrated in FIG. 5, the inter-component distance between the component (screw) A and the component B is determined not to satisfy the determination criteria. Thus, only the component (screw) A and the component B are displayed.

As illustrated in FIG. 5, the design support apparatus 1 according to the present embodiment not only displays the two component images but also highlight-displays the specific regions not satisfying the determination criteria. In the example of FIG. 5, the distance between the distal surface of the component (screw) A and the edge of the component B does not satisfy the determination criteria, and thus the two regions are highlight-displayed. The highlighted display allows the designer to instantly confirm the distance between which region and which region does not satisfy the determination criteria.

Further, as illustrated in FIG. 5, the design support apparatus 1 according to the present embodiment uses a bidirectional arrow to point to the two highlighted regions and displays a numerical value indicating the distance between the two regions. The designer can also get quantitative information from these displays. Note that as a screen example of FIG. 5, an error message may be displayed.

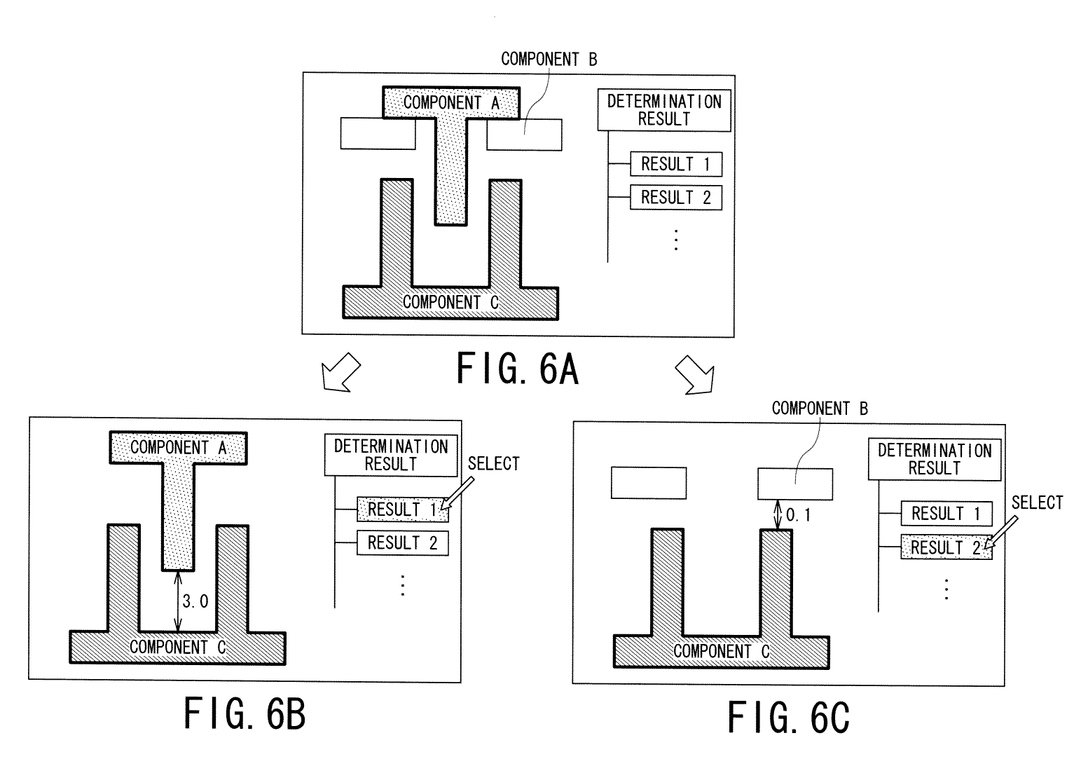

FIG. 6 illustrates a second display example of the determination result. Even if only the components determined not to satisfy the determination criteria are displayed, but if a plurality of verification items do not to satisfy the determination criteria, the number of components to be displayed may increase. In light of this, as illustrated in FIG. 6, the design support apparatus 1 according to the present embodiment displays the verification items not satisfying the determination criteria on a side of component images, for example, in a tree-like structure. FIG. 6A displays the images of all components not satisfying the determination criteria (in this example, the component A, the component B, and the component C). Here, when the result 1 of the verification item 1 is selected by a pointer or the like, the screen moves to a screen of FIG. 6B. FIG. 6B displays only the component A and the component C corresponding to the verification item 1 in such a manner that a bidirectional arrow points to the distal surface of the component A (screw) and the internal bottom surface of the component C (boss) not satisfying the determination criteria and the distance is numerically displayed. Then, when result 2 of the verification item 2 is selected, the screen moves to a screen of FIG. 6C. FIG. 6C displays only the component B and the component C corresponding to the verification item 2 in such a manner that a bidirectional arrow points to the rear surface of component B (board) and the upper surface of component C (boss) not satisfying the determination criteria and the distance is numerically displayed.

Thus, even if there are a large number of components not satisfying the determination criteria, a selection of each verification item result from the tree display allows the desired two components to be easily identified and the corresponding region and distance of the components to be visually verified in an easy manner.

The determination result can be stored in the determination result database 33 as an outcome in the course of design (step ST7 in FIG. 3). The designer concerned or other designers can call the determination results from the determination result database 33 any time to use them as the past design examples.

Note that, as described above, the client 2 can create and edit the content of the design criteria database 31.

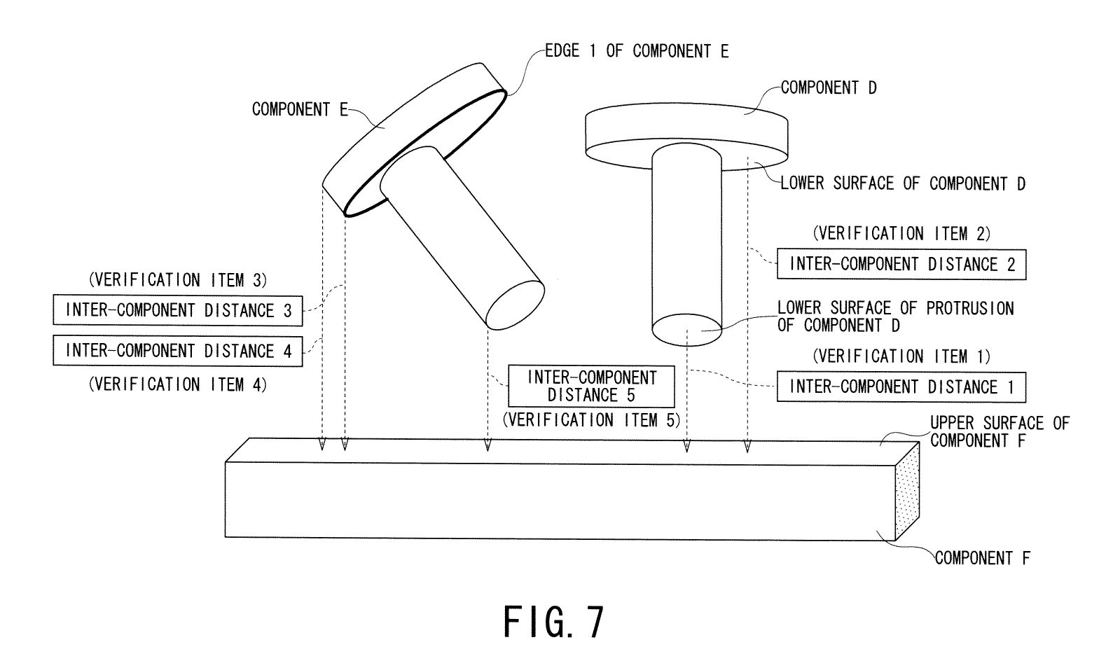

FIG. 7 illustrates another example of the component layout. For an example illustrated in FIG. 7, it is assumed that five verification items (verification items 1 to verification item 5) specifying five inter-component distances (inter-component distances 1 to inter-component distance 5) are created for three components (a component D, a component E, and a component F) and these design criteria are stored in advance in the design criteria database 31.

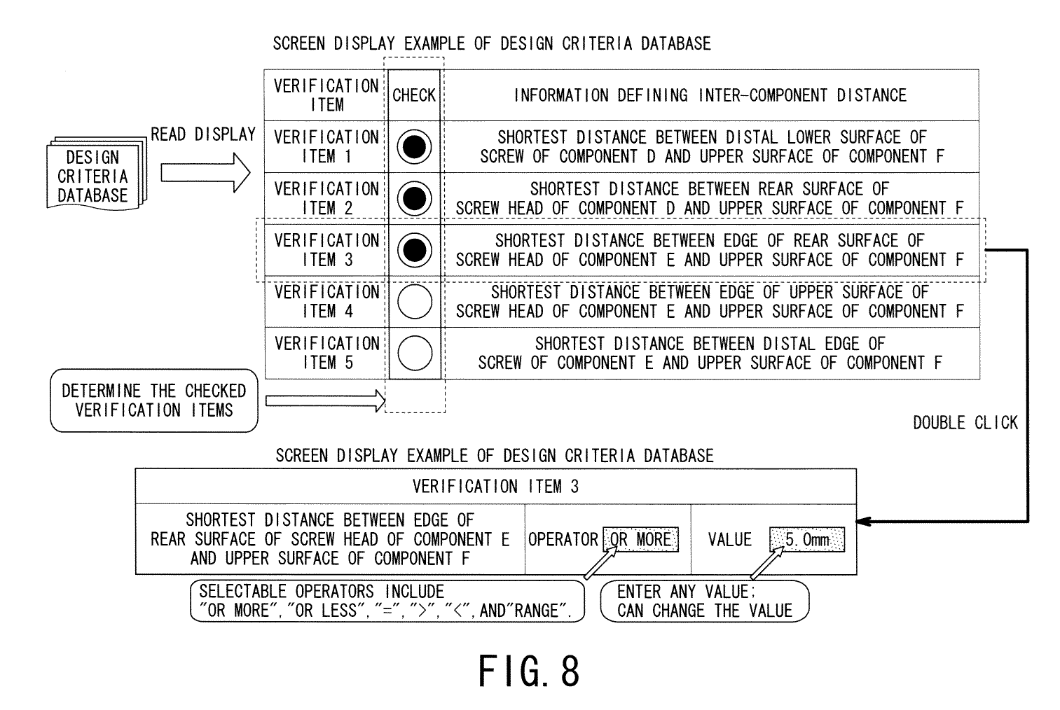

FIG. 8 illustrates a screen example in which the design criteria data is read from the design criteria database 31 and displayed on the display unit 22 of the client 2.

On this screen, a “check” column is provided between a “verification item” column and “information defining inter-component distance” column. By checking a verification item in the “check” column (indicated by a black circle), the verification item is selected to be executed. In other words, the process following step ST2 of FIG. 3 is executed only for the selected verification items.

Moreover, when a specific verification item row is double-clicked, the detailed setting screen is opened as illustrated on the lower portion of FIG. 8, and the determination criteria corresponding to the verification item are displayed. The user may change the displayed determination criteria. The changed determination criteria are applied to execute the verification item and the changed determination criteria may also be stored in the design criteria database 31. Examples of operators selectable for the determination criteria include “or more”, “or less”, “=”, “>”, “<”, and “range”. Thus, as described above, diversified determination criteria can be set. In addition, the value of the displayed determination criteria can also be changed.

As described above, the design support apparatus 1 and the design support method according to the present embodiment can efficiently perform design verification on inter-component distance and can handle diversified design verification items.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fail within the scope and spirit of the invention.

What is claimed is:

1. A design support apparatus comprising:
a component database in which 3D shape data of each component in equipment and 3D layout data of each component are stored as component data for each component;
a design criteria database, which is a database in which a plurality of verification items are stored, and in which information defining an inter-component distance between a first component and a second component to be verified and determination criteria used for verification of the inter-component distance are stored for each of the verification items;
a distance calculation unit which, based on the information defining the inter-component distance, extracts component data of each of the first component and the second component from the component database, and calculates the inter-component distance from each of the extracted component data for each of the verification items; and
a determination unit which determines whether or not the calculated inter-component distance satisfies the determination criteria for each of the verification items.

2. The design support apparatus according to claim 1, wherein
the information defining the inter component distance is information which specifies the shortest distance between a specific region on a surface of the first component and a specific region on a surface of the second component.

3. The design support apparatus according to claim 2, wherein
the specific region of each of the first component and the second component is a specific point, a specific edge, or a specific surface.

4. The design support apparatus according to claim 1, wherein
a plurality of a same type of components having a same 3D shape and being arranged in a different position are defined as any one of the first component and the second component.

5. The design support apparatus according to claim 1, wherein
as the determination criteria, any one of the inter-component distances being (1) equal to or greater than a predetermined design criterion; (2) equal to or less than a predetermined design criterion; (3) less than a predetermined design criterion; (4) greater than a predetermined design criterion; (5) the same as a predetermined design criterion; or (6) within a predetermined design criteria range is selectively stored in the design criteria database.

6. The design support apparatus according to claim 1,
further comprising a display unit which displays results determined by the determination unit,
wherein the display unit displays the shape and the layout of each component in the equipment as a 3D image or a 2D image in such a manner that only the first and second components determined not to satisfy the determination criteria are displayed and the other components are hidden.

7. The design support apparatus according to claim 6, wherein
the information defining the inter-component distance is information which specifies the shortest distance between one of a specific point, a specific edge, and a specific surface on a surface of the first component and one of a specific point, a specific edge, and a specific surface on a surface of the second component, and
the display unit highlight-displays the specific point, the specific edge, or the specific surface of the first and second components determined not to satisfy the determination criteria.

8. The design support apparatus according to claim 7, wherein
the display unit further displays an arrow connecting the positions each highlight-displayed on the first and second components and a numerical value indicating the calculated inter-component distance.

9. The design support apparatus according to claim 6, wherein
the display unit operates such that when a plurality of the verification items are determined that the inter-component distance does not satisfy the determination criteria, the plurality of verification items are displayed specifiably by a pointer and only the first and second components corresponding to the verification items specified by the pointer are displayed.

10. The design support apparatus according to claim 7, wherein
the display unit operates such that when a plurality of the verification items are determined that the inter-component distance does not satisfy the determination criteria, the plurality of verification items are displayed specifiably by a pointer and only the first and second components corresponding to the verification items specified by the pointer are displayed.

11. The design support apparatus according to claim 8, wherein
the display unit operates such that when a plurality of the verification items are determined that the inter-component distance does not satisfy the determination criteria, the plurality of verification items are displayed specifiably by a pointer and only the first and second components corresponding to the verification items specified by the pointer are displayed.

12. The design support apparatus according to claim 1,
further comprising a storage unit which stores results determined by the determination unit.

13. The design support apparatus according to claim 1,
further comprising a verification item selection unit which selects a verification item as specified from the plurality of verification items stored in the design criteria database, wherein
the distance calculation unit determines the inter-component distance for each of the selected verification items, and
the determination unit makes a determination for each of the selected verification items.

14. A design support method comprising:
storing 3D shape data of each component in equipment and 3D layout data of each component in a component database as component data for each component;
storing information defining an inter-component distance between a first component and a second component to be verified and determination criteria used for verification of the inter-component distance for each of the verification items in a design criteria database in which a plurality of verification items are stored;
extracting component data of each of the first component and the second component from the component database on the basis of the information defining the inter-component distance, and calculating the inter-component distance from each of the extracted component data for each of the verification items; and
determining whether or not the calculated inter-component distance satisfies the determination criteria for each of the verification items.
